(19) United States
(12) Patent Application Publication
(10) Pub. No.: US 2024/0036352 A1
(43) Pub. Date: Feb. 1, 2024

(54) FLOATING DISPLAY DEVICE

(71) Applicant: Darwin Precisions Corporation, Hsinchu County (TW)

(72) Inventors: CHIH-PING HSU, Hsinchu County (TW); RAN-SHIOU YOU, Hsinchu County (TW); YA HAN KO, Hsinchu County (TW)

(21) Appl. No.: 18/222,742

(22) Filed: Jul. 17, 2023

(30) Foreign Application Priority Data
Jul. 28, 2022 (TW) 111128433

(51) Int. Cl. G02B 30/56; G02B 30/27; G06F 3/042; G06F 3/041

(52) U.S. Cl. CPC G02B 30/56; G02B 30/27; G06F 3/0421; G06F 3/0412

(57) ABSTRACT

A floating display device which includes a display light source, an optical imaging sheet and a micro-lens array sheet is provided. The micro-lens array sheet has a plurality of micro-lenses arranged in an array. The optical imaging sheet has a plurality of sub-imaging units arranged in an array corresponding to the micro-lenses. The sub-imaging unit includes a plurality of first sub-imaging units and a plurality of second sub-imaging units. Each of the first sub-imaging units has a first main imaging pattern, and each of the second sub-imaging unit has a second main imaging pattern. The first main imaging pattern and the second main imaging pattern have the same pattern. Wherein, the second sub-imaging units are arranged to form an auxiliary imaging pattern. At least a number of the second sub-imaging units respectively include a base imaging pattern, and the base imaging pattern is located around the second main imaging pattern.

### CROSS-REFERENCE TO RELATED APPLICATION

This application claims the priority benefit of Taiwan application serial no. 111128433 filed on Jul. 28, 2022. The entirety of the above-mentioned patent application is hereby incorporated by reference herein and made a part of this specification.

### BACKGROUND

### Technical Field

The instant disclosure generally relates to a floating display device. Particularly, the instant disclosure relates to a floating display device with a wide viewing angle.

### Related Art

With the progress of display technologies, various novel display technologies have been continuously developed. In the field of projection display technology, since product size has been gradually miniaturized, small-sized micro-projection display technologies have been gradually developed and applied. Recently, micro-projection display technologies have been utilized to project images suspended in the air. The image formed by such a projection is called a “floating image.” Since a floating image is directly projected in the air, no display medium such as a display screen is required. Hence, floating display technologies have taken a more important role lately and a variety of applications have been developed.

In recent years, due to the rapid spread of diseases, contact transmission caused by the use of objects in public spaces has gradually attracted people's attention. Elevator bottoms, machine bottoms and touch screens in public spaces often become mediums of disease transmission. When a previous user leaves germs on an object after use, the next user may be easily inflected after touching the object and becomes the next disease communicator. Since floating display technologies do not require touching the objects, they have been gradually applied to objects for public use such as elevator bottoms, machine bottoms, touch screens, etc.

Floating display technology in combination with a floating touch technology can achieve a floating touch sensing effect for human-machine operation, and therefore the problem of contact transmission can be alleviated. However, at present, floating display technologies mainly project a floating image in front of the user, which can easily appear as an incomplete display image. Sometimes there may even be no image displayed, and thus cause inconvenience to the user. Hence, improving the viewing angle of the display image and still allowing the user to see the display image when it is deviating off the center front is a problem to be solved by a person skilled in the art.

### SUMMARY

An object of the instant disclosure is to provide a floating display device which has an enhanced display viewing angle to achieve the display effect of a wide viewing angle, and allow the user to clearly see the display image even from a tilted viewing angle.

An embodiment of the instant disclosure provides a floating display device which includes a display light source, an optical imaging sheet and a micro-lens array sheet. The micro-lens array sheet is disposed corresponding to the display light source, and the micro-lens array sheet has a plurality of micro-lenses arranged in an array. The optical imaging sheet is disposed between the display light source and the micro-lens array sheet. The optical imaging sheet has a plurality of sub-imaging units arranged in an array corresponding to the micro-lens. The plurality of sub-imaging units comprises a plurality of first sub-imaging units and a plurality of second sub-imaging units. Each of the first sub-imaging units has a first main imaging pattern. Each of the second sub-imaging units has a second main imaging pattern. The first main imaging pattern and the second main imaging pattern have the same pattern. Wherein, the plurality of second sub-imaging units is arranged to form an auxiliary imaging pattern. At least a number of the second sub-imaging units respectively have a base imaging pattern, and the base imaging pattern is located around the second main imaging pattern.

Another embodiment of the instant disclosure provides a floating display touch device comprising a display light source, a micro-lens array sheet, a touch sensing module and an optical imaging sheet. The micro-lens array sheet is disposed corresponding to the display light source, and the micro-lens array sheet has a plurality of micro-lenses arranged in an array. The touch sensing module is disposed adjacent to the micro-lens array sheet. The optical imaging sheet is disposed between the display light source and the micro-lens array sheet. The optical imaging sheet has a plurality of sub-imaging units arranged in an array corresponding to the micro-lenses. The plurality of sub-imaging units comprises a plurality of first sub-imaging units and a plurality of second sub-imaging units. Each of the first sub-imaging unit has a first main imaging pattern. Each of the second sub-imaging unit has a second main imaging pattern. The first main imaging pattern and the second main imaging pattern have the same pattern. Wherein, the plurality of second sub-imaging units is arranged to form an auxiliary imaging pattern. At least a number of the second sub-imaging units respectively have a base imaging pattern, and the base imaging pattern is located around the second main imaging pattern.

Compared to the conventional technology, the floating display device of the instant disclose uses the plurality of the arranged second sub-imaging units to form the auxiliary imaging pattern. A base imaging pattern is added to the peripheral of the second main imaging pattern of the second sub-imaging unit to enhance the effect of the auxiliary imaging pattern. The auxiliary display image provided by the auxiliary imaging pattern allows the user to still be able to see the auxiliary display image at a tilted viewing angle. Therefore, a wide-viewing angle display image can be achieved, and the user's experience of the floating display device can be improved. The floating display device of the instant disclosure, utilizing the aforementioned wide viewing angle display image, can achieve a wide viewing angle display effect.

### BRIEF DESCRIPTION OF THE DRAWINGS

FIG. 1 is a schematic side display view of the floating display device with wide viewing angle in an embodiment of the instant disclosure.

FIG. 2A is a schematic front view of the optical imaging sheet in an embodiment of the instant disclosure.

FIG. 2B is a schematic deconstructive drawing of the first sub-imaging units and the second sub-imaging units of the optical imaging sheet in an embodiment of the instant disclosure.

FIG. 3A is a schematic enlargement diagram of the first sub-imaging units of the optical imaging sheet in an embodiment of the instant disclosure.

FIG. 3B is a schematic enlargement diagram of the second sub-imaging units of the optical imaging sheet in an embodiment of the instant disclosure.

FIG. 4 is a schematic perspective view of the floating display device with a wide viewing angle in an embodiment of the instant disclosure.

FIG. 5A is a schematic arrangement diagram of the second sub-imaging units of the optical imaging sheet in an embodiment of the instant disclosure.

FIG. 5B is a schematic chessboard arrangement diagram of the second sub-imaging units of the optical imaging sheet in an embodiment of the instant disclosure.

FIGS. 6A-6C are schematic cross-sectional views of the optical imaging sheets in other embodiments of the instant disclosure.

FIG. 7 is a schematic enlargement diagram of the first sub-imaging units and the second sub-imaging units of the optical imaging sheet in another embodiment of the instant disclosure.

FIG. 8 is a schematic perspective view of the floating display device with a wide viewing angle in another embodiment of the instant disclosure.

FIG. 9 is a schematic cross-sectional view of the floating display device in another embodiment of the instant disclosure.

### DETAILED DESCRIPTION

In each of the embodiments of the instant disclosure, the term used herein is just for describing an object of a specific embodiment, and is not limited thereto. As used in this article, unless the content clearly indicating, the singular form “a”, “one” and “the” is intended to comprise a plural form including “at least one”. As used in the article, the term “a” comprises one or more related items and any or all combinations thereof.

In each of the embodiments of the instant disclosure, “above”, “under”, “left”, “right”, “front” and “rear” in the article are used to describe the relationship between one element and another element, and is used to explain the present position, but they do not limit the actual location thereof. The device in the attached diagrams does not limit the position and the orientation of its elements because of any rotation of the device.

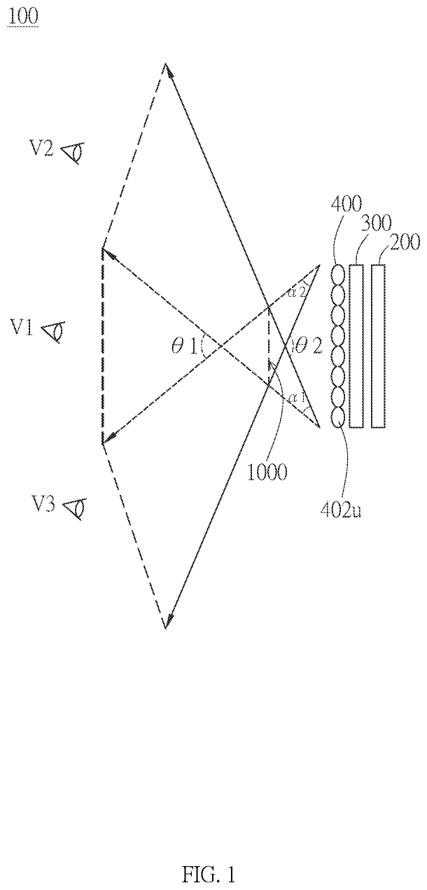

FIG. 1 is a schematic side display view of the floating display device with a wide viewing angle in an embodiment of the instant disclosure. Referring to FIG. 1, the floating display device 100 with a wide viewing angle of the instant disclosure at least comprises a display light source 200, an optical imaging sheet 300 and a micro-lens array (MLA) sheet 400. In this embodiment, the display light source 200, for example, may be a plane light source corresponding to the optical imaging sheet 300 and the MLA sheet 400 to provide the required light beams for displaying wide viewing angle images. The display light source 200 can provide, for example, various visible light beams including white light beams, blue light beams, green light beams, red light beams, etc., or mixed light beams thereof, for which the light wavelength range may be adjusted depending on the product requirement, but not limited thereto. The display light source 200 may be, for example, a Light Emitting Diode (LED), an Organic Light Emitting Diode (OLED), etc., but not limited thereto. The display light source 200 is not limited to one, and may be a plurality of light sources arranged in an array to enhance light source uniformity. In addition, the display light source 200 may be combined with various kinds of optical sheets, such as an optical diffusion sheet or a light guide plate, etc., to achieve uniform a light source effect.

Referring to FIG. 1, the MLA sheet 400 of the instant disclosure is disposed corresponding to the display light source to form and adjust a floating image. The MLA sheet 400 has a plurality of micro-lenses 402u, such as a M×N (M>1, N>1) array of arranged micro-lenses 402u. The number of the micro-lenses 402u may determine the fineness and the degree of three-dimensionality of the floating image. The array of the micro-lenses 402u, for example, may be a 40×40 micro-lens array to provide the floating display image with high fineness. The micro-lens 402u may be for example a micro-biconvex lens, as shown in FIG. 1, which can enhance the image focus effect, but not limited thereto. The micro-lens 402u also may be a micro-single convex lens, a micro-single concave lens, a micro-biconcave lens, a micro-concave convex lens, etc., and a combination thereof, but not limited thereto. In addition, the MLA sheet 400 is not limited to a single sheet, and may also be a combination of two sheets or multiple sheets to adjust the imaging effect. This is well known by a person skilled in the art, and it will not be described in detail herein.

The material of the MLA sheet 400 may be a transparent plastic material, a transparent glass material, a transparent ceramic material and a combination thereof, but not limited thereto. The transparent plastic material may be, for example, polyamine (PA), polyimide (PI), polycarbonate (PC), polyurethane (PU), polyethylenimine (PEI), polyethylene naphthalate (PEN), polyethylene terephthalate (PET), polyethersulfone (PES), fiber reinforced plastics (FPR), poly(methyl methacrylate (PMMA), polyetheretherketon (PEEK), polydimethylsiloxane (PDMS), etc., or other acrylate series polymer, ether series polymer, polyolefin series polymer, epoxy resin series polymer, other suitable material, or a combination of the above materials, but not limited thereto. The transparent glass material may be, for example, soda lime glass, borosilicate glass, lead glass, quartz glass, tempered glass, etc., or a combination thereof, but not limited thereto. Transparent ceramic material may be, for example, transparent aluminum oxide, transparent aluminum nitride, transparent silicon oxide, transparent silicon nitride, etc., or a combination thereof, but not limited thereto.

Referring to FIG. 1, the optical imaging sheet 300 is disposed between the display light source 200 and the MLA sheet 400 to form a required pattern of the floating display image. The optical imaging sheet 300 has a plurality of sub-imaging units arranged in an array (explained in following drawings.) For example, it may be a M×N (M>1, N>1) array of arranged sub-imaging units, and each of the sub-imaging unit corresponds to a micro-lens 402u.

The floating display device 100 of the instant disclosure can achieve the effect of a wide viewing angle. The display light source 200, the optical imaging sheet 300 and the MLA sheet 400 of the floating display device 100 project light to form a floating display image 1000. When a user sees the floating display image 1000 produced by the floating display device 100 at a first viewing angle V1, the user can see a good floating display image 1000 because the user is located within the field of view (FOV) for front viewing, but it is limited to the range of a viewing angle θ1. For example, the normal direction vertical to the center of the plane of the optical imaging sheet 300 is 0 degree (not shown). Depending on the limitation of the viewing angle of the product, the viewing angle θ1 may be, for example, ±25 degrees. The viewing angle θ1 limits the viewing angle of the user, and also limits the application of the product. The floating display device 100 with a wide viewing angle of the instant disclosure further provides an auxiliary display image (explanation below) which can increase the viewing angle to a viewing angle of θ2, such as ±50 degrees. The user can see the auxiliary display image at a second viewing angle V2 and a third viewing angle V3, which are both deviated, and thus an auxiliary viewing angle α1 (+25 degrees to +50 degrees) and an auxiliary viewing angle α2 (−25 degrees to −50 degrees) are added. The above two are only examples using the up and down deviated viewing angles. However, the angle added by the auxiliary display image is a 3D viewing angle. Therefore, when the user deviates from the first viewing angle V1 for front viewing, the user can still see the display image, regardless if the deviation is in the up, down, left, or right direction, and is not limited by the example illustrated in FIG. 1. Compared to the conventional technology, which only allows the user to see at the first viewing angle V1 with a small viewing angle θ1, the instant disclosure provides the auxiliary display image, which increases the viewing angle to θ2, and thus adds the deviated viewing angles α1 and α2. The user can see the auxiliary display image at the deviated second viewing angle V2 and third viewing angle V3. Hence, the floating display device 100 of the instant disclosure increases the range of application of the floating display technology and improves the experience of the user during their use of the floating display device.

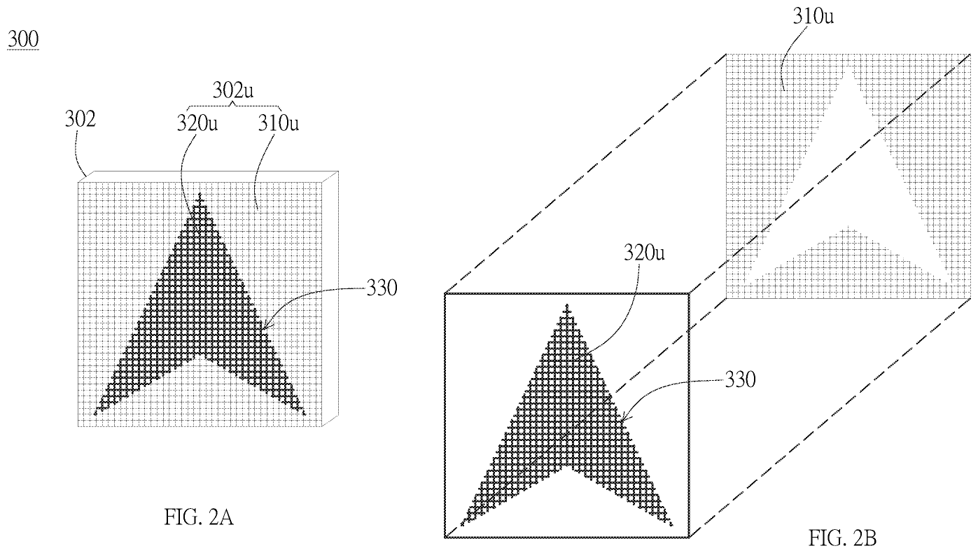

FIG. 2A is a schematic front view of the optical imaging sheet in an embodiment of the instant disclosure. FIG. 2B is a schematic deconstructive drawing of the first sub-imaging units and the second sub-imaging units of the optical imaging sheet in an embodiment of the instant disclosure. Referring to FIGS. 1, 2A and 2B, in this embodiment, we use only a pattern of “upward arrows” as an example to explain the floating display image 1000 of the instant disclosure. A person skilled in the art can adjust the required display image of the floating display image 1000 depending on the product requirement. The optical imaging sheet 300 of the instant disclosure includes a plurality of sub-imaging units 302u. For example, it may be a M×N (M>1, N>1) array of arranged sub-imaging units 302u, which forms the required pattern for the floating display image 1000. The number of the sub-imaging units 302u can determine the fineness and the degree of three-dimensionality of the floating image. The array of the sub-imaging units 302u may be for example a 40×40 sub-imaging unit array to provide a floating display image with high fineness. Each of the sub-imaging unit 302u corresponds to a micro-lens 402u, and the array of a plurality of arranged sub-imaging units 302u forms an imaging pattern layer 302. The array of a plurality of the arranged sub-imaging units 302u includes a plurality of first sub-imaging units 310u and a plurality of second sub-imaging units 320u, wherein a plurality of the second sub-imaging units 320u form an auxiliary imaging pattern 330.

Referring to FIG. 2B, the array of the arranged sub-imaging units 302u can be divided into two parts—the top right corner drawing at the back and the lower left corner drawing at the front, based on the arrangement of the plurality of the first sub-imaging units 310u and the plurality of the second sub-imaging units 320u. Wherein, the top right drawing is a pattern arranged of the plurality of the first sub-imaging units 310u, in which the blank part at the center is the part excluding the second sub-imaging units 320u. The lower left drawing is a pattern arranged of the plurality of the second sub-imaging units 320u, in which the central part is arranged to form the auxiliary imaging pattern 330. The auxiliary imaging pattern 330 forms the required pattern for forming a wide viewing angle display image, and the peripheral blank part is the part excluding the first sub-imaging units 310u.

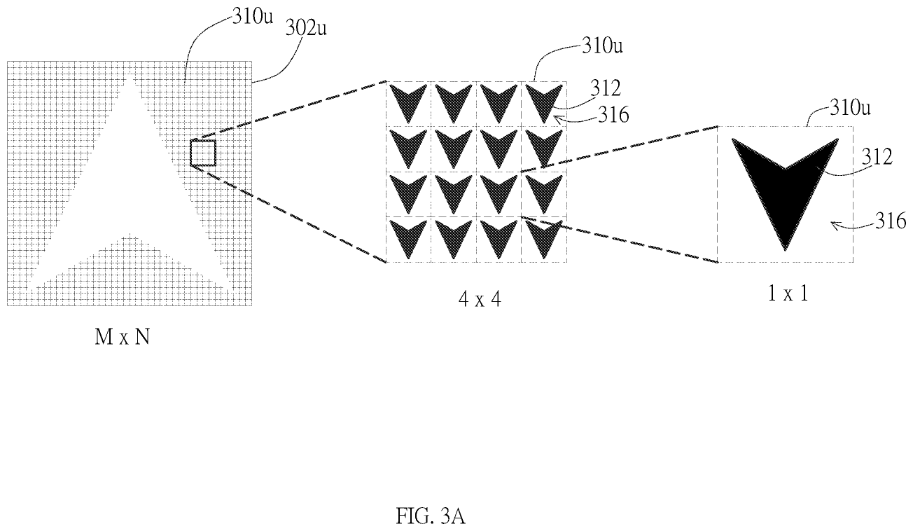

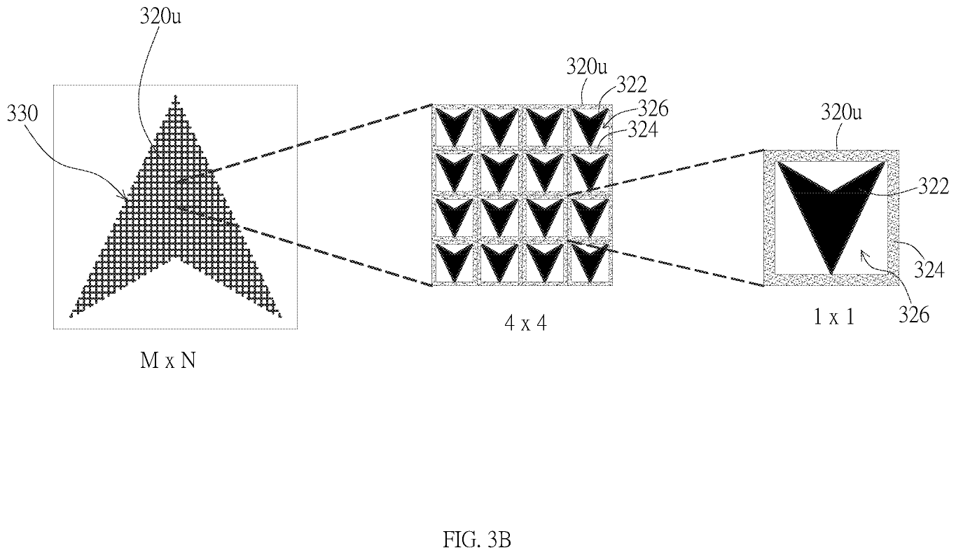

FIG. 3A is a schematic enlargement diagram of the first sub-imaging units of the optical imaging sheet in an embodiment of the instant disclosure. FIG. 3B is a schematic enlargement diagram of the second sub-imaging units of the optical imaging sheet in an embodiment of the instant disclosure. FIG. 4 is a schematic perspective view of the floating display device with a wide viewing angle in an embodiment of the instant disclosure. This embodiment is similar to the previous embodiments in FIGS. 1-2B, and the same reference numbers are used for cross-referencing, but not limited thereto. Referring to FIGS. 1, 2A and 3A, each of the first sub-imaging units 310u respectively includes a first main imaging pattern 312 corresponding to the pattern of the floating display image 1000. Using a 40×40 array of arranged sub-imaging units 302u as an example, the length and the width of each of the first sub-imaging units 310u may be respectively 1/40 of the length and the width of the floating display image 1000. A plurality of the first main imaging pattern 312 corresponding to the first sub-imaging units 310u are used for projection to enhance the fineness of the floating display image 1000. As shown in FIG. 3A, a M×N array of arranged first sub-imaging units 310u are locally enlarged into a 4×4 array of arranged first sub-imaging units 310u. Each of the first sub-imaging units 310u includes a first main imaging pattern 312, and the residual part is a first residual pattern 316. The 4×4 array of arranged first sub-imaging units 310u are locally enlarged into a 1×1 first sub-imaging unit 310u, and the first main imaging pattern 312 that can be seen is a downward arrow pattern. In this embodiment, a light shielding pattern is used as an example of the first main imaging pattern 312, and the residual part is the first residual pattern 316, which is a light transmitting pattern opposite to the light shielding pattern. Therefore, in the center of the pattern of the projected floating display image 1000 is a light-shielding dark upward arrow pattern, and the related peripheral region is a light-transmitting bright pattern, as shown in FIG. 4. The orientation of the first main imaging pattern 312 is determined depending on the projection system of the micro-lenses 402u for the first main imaging pattern 312. For example, the micro-lenses 402u can be micro-biconvex lenses. Because the projected image is an enlarged real image, the first main imaging pattern 312 corresponding to the pattern of the floating display image 1000 is a reversed, downward arrow pattern, which is rotated 180 degrees downward on the projection plane. Therefore, the pattern of the floating display image 1000 projected by the first main imaging pattern 312 is correspondingly an upward arrow pattern. The above description is just an example. A person skilled in the art can properly modify the projection system. For example, when the first main imaging pattern 312 is an upward arrow pattern, the projected pattern of the floating display image 1000 is correspondingly an upward arrow pattern, but not limited thereto. This is well known by a person skilled in the art, and it will not be described in detail herein.

Referring to FIGS. 1, 2A, 3A and 3B, in this embodiment, each of the second sub-imaging units 320u respectively includes a second main imaging pattern 322 and a base imaging pattern 324, and the residual part is a second residual pattern 326. As shown in FIG. 3B, the plurality of second sub-imaging pattern units 320 are arranged to form an auxiliary imaging pattern 330, as shown by the upward arrow in the left drawing of FIG. 3B, which is the required pattern for a wide viewing angle display image. Each of the second sub-imaging units 320u, for example, may have the same length and width as the first sub-imaging unit 310u, wherein the second main imaging pattern 322, for example, may also have the same length and width as the first main imaging pattern 312, but not limited thereto. The first main imaging pattern 312 and the second main imaging pattern 322 have the same pattern. The function of the second main imaging pattern 322 is similar to that of the first main imaging pattern 312. By utilizing the projection of the second main imaging pattern 322, the fineness of the floating display image 1000 can be therefore increased.

In this embodiment, as shown in FIG. 3B, the M×N array of arranged second sub-imaging units 320u are locally enlarged into a 4×4 array of arranged second sub-imaging units 320u. Each of the second sub-imaging units 320u includes a second main imaging pattern 322 and a base imaging pattern 324, and the residual part is the second residual pattern 326. The 4×4 array of arranged second sub-imaging units 320u are locally enlarged into a 1×1 second sub-imaging unit 320u, and the second main imaging pattern 322 that can be seen is a downward arrow pattern. The second main imaging pattern 322 is similar to the first main imaging pattern 312. As an example, the second main imaging pattern 322 and the base imaging pattern 324 may be light shielding patterns, and the residual part, i.e., the second residual pattern 326, may be a light transmitting pattern opposite to the light shielding pattern. Therefore, in the center of the pattern of the projected floating display image 1000 is a light-shielding dark upward arrow pattern, and the related peripheral region is a light-transmitting bright pattern, as shown in FIG. 4. The orientation of the second main imaging pattern 322 is determined depending on the projection system of the micro-lenses 402u for the second main imaging pattern 322. As an example, the micro-lenses 402u may be micro-biconvex lenses. Because the projected image is an enlarged real image, the second main imaging pattern 322 corresponding to the pattern of the floating display image 1000 is a reversed downward arrow pattern, which is rotated 180 degrees downward on the projection plane. The pattern of the floating display image projected by the second main imaging pattern 322 is correspondingly an upward arrow pattern. The above description is just an example. A person skilled in the art can properly modify the projection system. For example, the second main imaging pattern 322 may be an upward arrow pattern, and the projected pattern of the floating display image 1000 is correspondingly an upward arrow pattern; but modifications are not limited thereto. This is well known by a person skilled in the art, and it will not be described in detail. In this embodiment, the first main imaging pattern 312 and the second main imaging pattern 322 have the same pattern. The user can see the floating display image 1000 from the front-viewing first viewing angle V1 after projection, as shown in FIG. 1 and FIG. 4.

Referring to FIGS. 1-3B, in this embodiment, the base imaging pattern 324 of the second sub-imaging unit 320u is located around the second main imaging pattern 322. For example, the base imaging pattern 324 may surround the second main imaging pattern 322 to enhance the display effect of the base imaging pattern 324, but not limited thereto. The base imaging pattern 324, for example, may be only half of a pattern disposed on the right half side or the left half side, or disposed at the four sides or the four corners (not shown). By adjusting the ratio of the pattern area of the base imaging pattern 324, the light shielding gray scale effect of the auxiliary imaging pattern 330 can be correspondingly adjusted, and thus the brightness of the auxiliary display image at a tilted angle can be correspondingly adjusted. In this embodiment, the plurality of the second sub-imaging units 320u form the auxiliary imaging pattern 330. The auxiliary imaging pattern 330 has the same or similar pattern as the first main imaging pattern 312, and thus the auxiliary imaging pattern 330 has the same or similar pattern as the floating display image 1000. The auxiliary display image can be seen from the second viewing angle V2 and the third viewing angle V3 after the auxiliary imaging pattern 330 is projected, as shown in FIG. 1 and FIG. 4.

Please refer to FIGS. 1-4. In FIG. 4, the floating display device with a wide viewing angle in FIG. 1 is represented only by the key component, the optical imaging sheet 300. The optical imaging sheet 300 includes a first main imaging pattern 312, a second imaging pattern 322 and an auxiliary imaging pattern 330. The floating display device 100 of the instant disclosure can achieve a wide viewing angle effect. When the user sees the optical imaging sheet 300 of the floating display device 100 from the front-viewing first viewing angle V1, and the first main imaging pattern 312 and the second main imaging pattern 322 are projected to generate the floating display image 1000, since the user is located in the range of the field of view (FOV) 1200 for front viewing, an excellent floating display image 1000 can be seen, but it is limited to the range of the viewing angle θ1. For example, if the normal direction vertical to the center of the plane of the optical imaging sheet 300 is 0 degree (not shown), depending on the limitation of the viewing angle of the product, the viewing angle θ1 may be, for example, ±25 degrees. The viewing angle θ1 limits the viewing angle of the user, and it also limits the application of the product. The floating display device 100 with a wide viewing angle of the instant disclosure further provides an auxiliary display image projected by the auxiliary imaging pattern 330 of the optical imaging sheet 300, which can increase the viewing angle to a viewing angle θ2, such as ±50 degrees. The user can see the auxiliary display image at the deviated top second viewing angle V2 (+25 degrees to +50 degrees) and the deviated lower third viewing angle V3 (−25 degrees to −50 degrees), and thus the auxiliary viewing angles α1 and α2 are added. The added part of the auxiliary display image is a 3D viewing angle. When the user deviates from the front-viewing first viewing angle V1, regardless of whether the deviation is upward, downward, left or right, the user can still see the auxiliary display image, and it is not limited to the demonstration illustrated in FIG. 4. Compared to the conventional technology, with which the user can only see from the first viewing angle V1 with a small viewing angle θ1, the instant disclosure provides an auxiliary display image with an increased viewing angle θ2 and added the deviated viewing angles α1 and α2, allowing the user to see the auxiliary display image even from the deviated second viewing angle V2 and third viewing angle V3. Hence, the floating display device 100 with a wide viewing angle of the instant disclosure increases the range of application and improves the user's viewing experience of the floating display device. In addition to the pattern of upward arrow for the floating display image 1000 illustrated in FIG. 4, the optical imaging sheet 300 may also use various other different patterns such as number patterns, direction patterns, switch on/off patterns, text patterns, etc., and the floating display image 1000 is correspondingly formed with the above patterns, but not limited thereto, and the details will not be described herein.

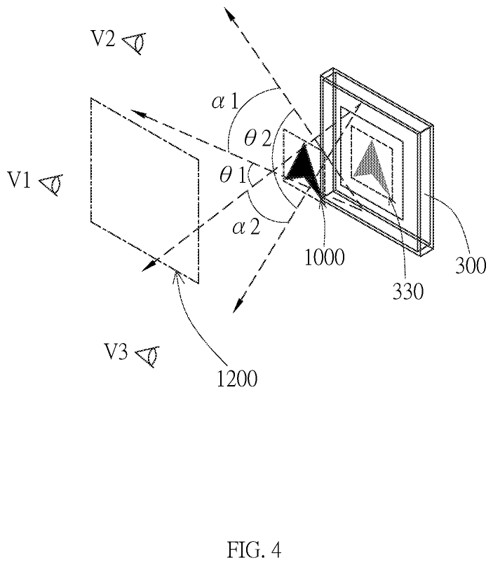

FIG. 5A is a schematic arrangement diagram of the second sub-imaging units of the optical imaging sheet in an embodiment of the instant disclosure. Referring to FIGS. 3B and 5A, a plurality of second sub-imaging display units 320u arranged in a 6×6 array is used as an example. In this embodiment, the second main imaging pattern 322 and the base imaging pattern 324 respectively use a light shielding pattern as an example, and the residual part is the second residual pattern 326, which is a light transmitting pattern opposite thereto. Each of the second sub-imaging units 320 has a base imaging pattern 324, and the base imaging pattern 324 in each of the second sub-imaging units 320 surrounds the second main imaging pattern 322. Hence, the auxiliary imaging pattern 330 has the highest light shielding effect. When the user sees the auxiliary display image at a tilted angle, the auxiliary display pattern has the darkest gray scale and the highest display contrast ratio to the peripheral light transmitting part.

FIG. 5B is a schematic chessboard arrangement diagram of the second sub-imaging units of the optical imaging sheet in an embodiment of the instant disclosure. If it is required by the product, the gray scale display effect of the auxiliary imaging pattern 330 can be adjusted. In addition to the aforementioned adjusting method that adjusts the pattern area of the single base imaging pattern 324, the ratio of the base imaging pattern 324 in the auxiliary imaging pattern 330 may also be adjusted to achieve a similar adjusting effect. As shown in FIG. 5B, at least a part of the second sub-imaging units 320ua in all of the second sub-imaging units 320u respectively have a base imaging pattern 324. Therefore, a part of the second sub-imaging units 320ua respectively have a base imaging pattern 324, and the other part of the second sub-imaging units 320ub respectively do not have a base imaging pattern 324. Wherein, each of the second sub-imaging units 320ua has a second main imaging pattern 322, a base imaging pattern 324, and a second residual pattern 326a, and each of the second sub-imaging units 320ub has a second main imaging pattern 322 and a second residual pattern 326b. The second imaging units 320ua with the base imaging pattern 324 are arranged, for example, in a chessboard arrangement. The second sub-imaging units 320ua and the second sub-imaging units 320ub are alternatively arranged as shown in FIG. 5B. The above description is used as an example. The second imaging units 320ua with the base imaging pattern 324 may also be arranged using other arrangements, such as a strip-like alternative arrangement, a triangle staggered arrangement, a square staggered arrangement, a random staggered arrangement, etc., but not limited thereto. By adjusting the ratio of the base imaging pattern 324 in the auxiliary imaging pattern 330, the display effect of the auxiliary imaging pattern 330 can be correspondingly adjusted. For example, the light shielding effect may be adjusted to half, but not limited thereto.

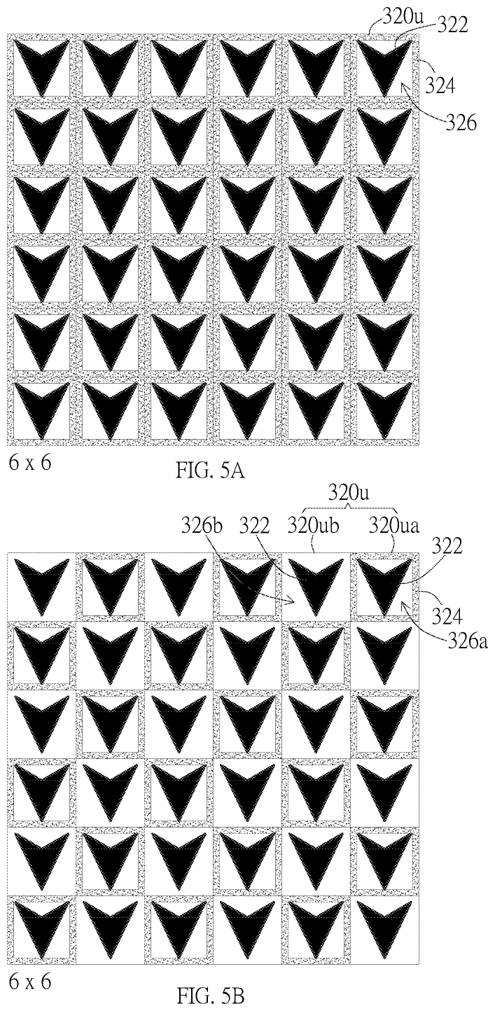

FIG. 6A is a schematic cross-sectional view of an optical imaging sheet 300a in another embodiment of the instant disclosure. Referring to FIGS. 2A and 6A, an array of a plurality of arranged sub-imaging units 302u form the imaging pattern layer 302. If the pattern of the imaging pattern layer 302 allows, the optical imaging sheet 300 may only use an imaging pattern layer 302. However, if the imaging pattern layer 302 is not continuous, a transparent substrate 304 may be attached thereto to increase the stability of the imaging pattern layer 302. For example, the optical imaging sheet 300a may include an imaging pattern layer 302 and a transparent substrate 304. The transparent substrate 304 has a first surface 3041 and a second surface 3042. The imaging pattern layer 302 may be disposed on the first surface 3041 of the transparent substrate 304. Therefore, an array of a plurality of the arranged sub-imaging units 302u of the imaging pattern layer 302 is correspondingly disposed on the transparent substrate 304, and thereby increases the stability of the sub-imaging units 302u. In FIG. 6A, the imaging pattern layer 302 is represented by only a single layer. The imaging pattern layer 302 may present a cross-sectional pattern with discontinuous segments, due to the differences in various positions of the cross-sectional lines or different patterns. For example, the first surface 3041 of the transparent substrate 304 may face the MLA sheet 400, and the second surface 3042 of the transparent substrate 304 may face the display light source 200. By properly adjusting the projective object distance and image distance of the floating projection system, an excellent floating display image 1000 can be formed.

FIG. 6B is a schematic cross-sectional view of an optical imaging sheet 300b in another embodiment of the instant disclosure. Referring to FIGS. 2A and 6B, in addition to being disposed on the first surface 3041 of the transparent substrate 304, the imaging pattern layer 302 of the optical imaging sheet 300b may also be disposed on the second surface 3042 of the transparent substrate 304. Therefore, an array of a plurality of the arranged sub-imaging units 302u of the imaging pattern layer 302 is correspondingly disposed on the transparent substrate 304, and thereby increases the stability of the sub-imaging units 302u. In FIG. 6B, the imaging pattern layer 302 is represented by only a single layer. The imaging pattern layer 302 may present a cross-sectional pattern with discontinuous segments, due to the differences in various positions of the cross-sectional lines or different patterns. For example, the first surface 3041 of the transparent substrate 304 may face the MLA sheet 400, and the second surface 3042 of the transparent substrate 304 may face the display light source 200. By properly adjusting the projective object distance and image distance of the floating projection system, an excellent floating display image 1000 can be formed.

FIG. 6C is a schematic cross-sectional view of an optical imaging sheet 300c in another embodiment of the instant disclosure. Referring to FIGS. 2A and 6C, the imaging pattern layer 302 of the optical imaging sheet 300c may be sandwiched inside the transparent substrate 304. Therefore, an array of a plurality of the arranged sub-imaging units 302u of the imaging pattern layer 302 is correspondingly disposed on the transparent substrate 304, and thereby increases the stability of the sub-imaging units 302u. In FIG. 6C, the imaging pattern layer 302 is represented by only a single layer. The imaging pattern layer 302 may present a cross-sectional pattern with discontinuous segments, due to the differences in various positions of the cross-sectional lines or different patterns. For example, the first surface 3041 of the transparent substrate 304 may face the MLA sheet 400, and the second surface 3042 of the transparent substrate 304 may face the display light source 200. By properly adjusting the projective object distance and image distance of the floating projection system, an excellent floating display image 1000 can be formed.

In the embodiments of the instant disclosure, the array of arranged sub-imaging units 302u are disposed on the transparent substrate 304. This may generally refer to the situations that the array of arranged sub-imaging units 302u are disposed on or in one of the first surface 3041 of the transparent substrate 304, the second surface 3042 of the transparent substrate 304, or the interior of the transparent substrate 304, but not limited thereto.

In an embodiment of the instant disclosure, the material of the transparent substrate may include a transparent plastic material, a transparent glass material, a transparent ceramic material or a combination thereof, but not limited thereto. The transparent plastic material may be, for example, polyamine (PA), polyimide (PI), polycarbonate (PC), polyurethane (PU), polyethylenimine (PEI), polyethylene naphthalate (PEN), polyethylene terephthalate (PET), polyethersulfone (PES), fiber reinforced plastics (FPR), poly(methyl methacrylate (PMMA), polyetheretherketon (PEEK), polydimethylsiloxane (PDMS), or other acrylate series polymer, ether series polymer, polyolefin series polymer, epoxy resin series polymer, other suitable material, or a combination of above materials, but not limited thereto. The transparent glass material may be, for example, soda lime glass, borosilicate glass, lead glass, quartz glass, tempered glass, or a combination thereof, but not limited thereto. Transparent ceramic material may be, for example, transparent aluminum oxide, transparent aluminum nitride, transparent silicon oxide, transparent silicon nitride, or a combination thereof, but not limited thereto.

In an embodiment of the instant disclosure, the material of the imaging pattern layer 302 (formed by an array of arranged sub-imaging units 302u) may be a light shielding material, such as a light shielding plastic material, a light shielding metal material or a light shielding ceramic material, or a stacked layer thereof or a combination thereof, but not limited thereto. The light shielding plastic material may be, for example, black ink, light shielding resin, etc., but not limited thereto. The light shielding metal material may be, for example, chromium, molybdenum, aluminum, titanium, zinc, manganese, silver, etc., but not limited thereto. The light shielding ceramic material may be, for example, various metal oxide and metal nitride such as chromium oxide, titanium oxide, chromium nitride, titanium nitride, etc., but not limited thereto. Technologies such as coating, evaporation, and sputtering may be used on the imaging pattern layer 302 to form one or more layers of the above material on the transparent substrate 304. The thickness may be, for example, between 1 micrometer (μm) and 1000 μm, but not limited thereto. Patterning technologies such as photolithography and etching processes, etc., may be used to form the required imaging pattern layer 302. This is well known by a person skilled in the art, and it will not be described in detail.

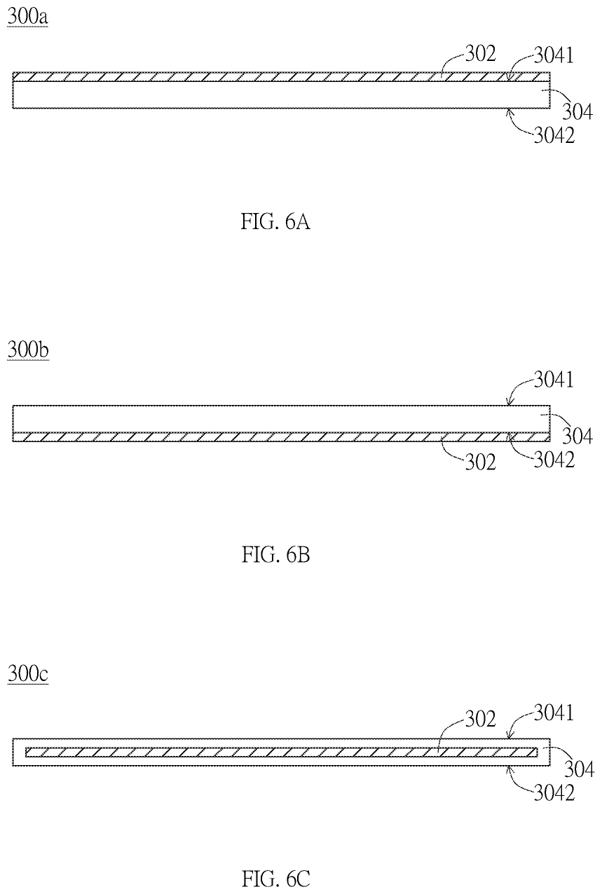

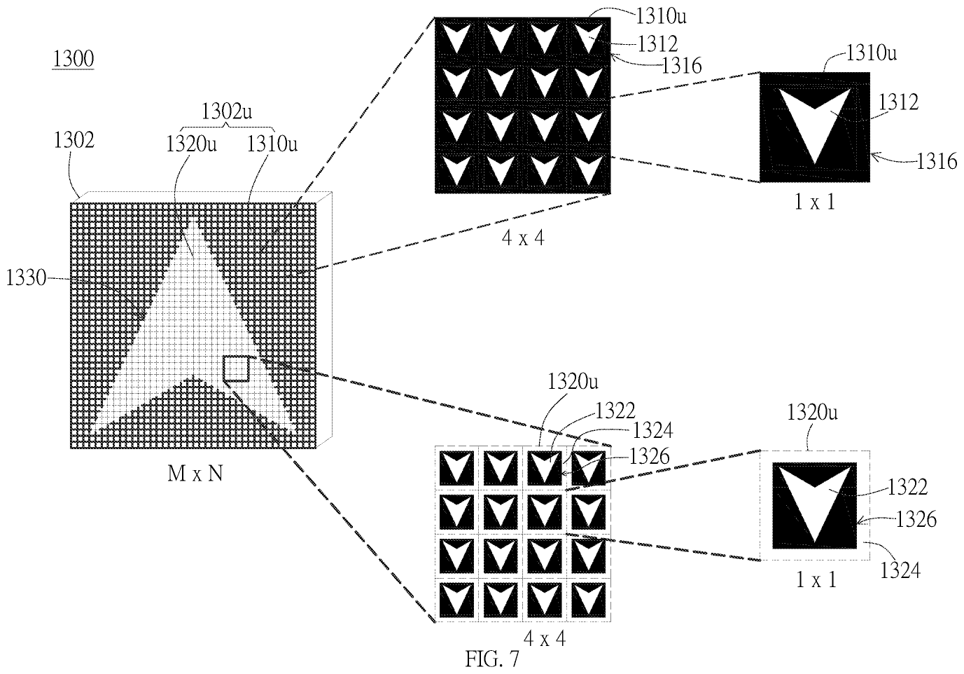

FIG. 7 is a schematic enlargement diagram of the first sub-imaging units 1310u and second sub-imaging units 1320u of an optical imaging sheet 1300 in another embodiment of the instant disclosure. FIG. 8 is a schematic perspective view of the floating display device with a wide viewing angle in another embodiment of the instant disclosure. In this embodiment, similar to the previous illustrated embodiments of FIGS. 1-6C, the same reference numbers are used for cross-referencing, but it is not limited thereto. In addition to using a light shielding pattern, in another embodiment, a light transmitting pattern may be used. Referring to FIGS. 1, 7 and 8, in another embodiment, the optical imaging sheet 300 with a light shielding pattern may be replaced by the optical imaging sheet 1300 with a light transmitting pattern to present another display effect.

Referring to FIGS. 1, 7 and 8, in this embodiment, the floating display image 1000 is illustrated instead by a “light transmitting upward arrow” pattern. The optical imaging sheet 1300 of the instant disclosure has a plurality of sub-imaging units 1302u arranged in an array. For example, it may be a M×N (M>1, N>1) array of arranged sub-imaging units 1302u to form the required pattern. The array of the sub-imaging units 1302u may be, for example, a 40×40 sub-imaging unit array. The length and width of each of the sub-imaging units 1302u may be, for example, respectively 1/40 of the length and width of the floating display image 1000. A plurality of the sub-imaging units 1302u are used for projecting display, and thus the fineness of the floating display image 1000 can be increased. Each of the sub-imaging units 1302u is arranged corresponding to the micro-lenses 402u. An array of a plurality of the arranged sub-imaging units 1302u forms an imaging pattern layer 1302. The array of a plurality of the arranged sub-imaging units 1302u includes a plurality of the first sub-imaging units 1310u and a plurality of the second sub-imaging units 1320u, wherein a plurality of the second sub-imaging units 1320u form an auxiliary imaging pattern 1330 that is a required auxiliary pattern for forming a wide viewing angle display image.

Referring to FIG. 1 and FIG. 7, each of the first sub-imaging units 1310u respectively has a first main imaging pattern 1312 corresponding to the pattern of a floating display image 1000a. A plurality of the first main imaging pattern 1312 corresponding to the first sub-imaging units 1310u are used for projection to enhance the fineness of the floating display image 1000a. As shown in FIG. 7, the first sub-imaging units 1310u are locally enlarged into a 4×4 array of arranged first sub-imaging units 1310u. Each of the first sub-imaging units 1310u includes a first main imaging pattern 1312, and the residual part is a first residual pattern 1316. The 4×4 array of arranged first sub-imaging units 1310u are locally enlarged into a 1×1 first sub-imaging unit 1310u, and one can see that the first main imaging pattern 1312 is a light-transmitting downward arrow pattern. In this embodiment, the first main imaging pattern 1312 uses a light transmitting pattern as an example, and the residual part is the first residual pattern 1316 which is a light shielding pattern opposite to the light transmitting pattern. Therefore, in the center of the pattern of the projected floating display image 1000a is a light-transmitting bright upward arrow pattern, and the related peripheral region is a light-shielding dark pattern, as shown in FIG. 8. The orientation of the first main imaging pattern 1312 is determined depending on the projection system of the micro-lenses 402u for the first main imaging pattern 1312. The micro-lenses 402u may be micro-biconvex lenses, for example. Because the projected image is an enlarged real image, the first main imaging pattern 1312 corresponding to the pattern of the floating display image 1000a is a reversed downward arrow pattern, which is rotated 180 degrees downward on the projection plane. Therefore, the pattern of the floating display image 1000a projected by the first main imaging pattern 1312 is correspondingly an upward arrow pattern. The above description is just an example. A person skilled in the art can properly modify the projection system. For example, the first main imaging pattern 1312 may be an upward arrow pattern, and the projected pattern of the floating display image 1000a may correspondingly be an upward arrow pattern, but not limited thereto. This is well known by a person skilled in the art, and it will not be described in detail herein.

Referring to FIG. 1 and FIG. 7, in this embodiment, each of the second sub-imaging units 1320u respectively includes a second main imaging pattern 1322 and a base imaging pattern 1324, which correspond to the pattern of the floating display image 1000a. Moreover, a plurality of the second sub-imaging pattern units 1320 are arranged to form the auxiliary imaging pattern 1330, as shown by the upward arrow in the left drawing of FIG. 7, and it produces the required pattern for a wide viewing angle display image. Each of the second sub-imaging units 1320u, for example, may have the same length and width as that of the first sub-imaging unit 1310u, wherein the second main imaging pattern 1322, for example, may also have the same length and width as that of the first main imaging pattern 1312, but not limited thereto. The first main imaging pattern 1312 and the second main imaging pattern 1322 have the same pattern. The function of the second main imaging pattern 1322 is similar to that of the first main imaging pattern 1312. By utilizing the projection of the second main imaging pattern 1322, the fineness of the floating display image 1000a can be therefore increased. In this embodiment, as shown in FIG. 7, the second sub-imaging units 1320u are locally enlarged into a 4×4 array of arranged second sub-imaging units 1320u. Each of the second sub-imaging units 1320u includes a second main imaging pattern 1322 and a base imaging pattern 1324, and the residual part is a second residual pattern 1326. The 4×4 array of arranged second sub-imaging units 1320u are locally enlarged into a 1×1 second sub-imaging unit 1320u, and one can see that the second main imaging pattern 1322 is a light-transmitting downward arrow pattern. The second main imaging pattern 1322 is similar to the first main imaging pattern 1312. The second main imaging pattern 1322 and the base imaging pattern 1324 use a light transmitting pattern as an example, and the residual part is the second residual pattern 1326 which is a light shielding pattern opposite to the light transmitting pattern. Therefore, in the center of the pattern of the projected floating display image 1000a is a light-transmitting bright upward arrow pattern, and the related peripheral region is a light-shielding dark pattern, as shown in FIG. 8. The orientation of the second main imaging pattern 1322 is determined depending on the projection system of the micro-lenses 402u for the second main imaging pattern 1322. The micro-lenses 402u may be micro-biconvex lenses, for example. Because the projected image is an enlarged real image, the second main imaging pattern 1322 corresponding to the pattern of the floating display image 1000a is a reversed downward arrow pattern, which is rotated 180 degrees downward on the projection plane. The pattern of the floating display image 1000a projected by the second main imaging pattern 1322 is correspondingly an upward arrow pattern. The above description is just an example. A person skilled in the art can properly modify the projection system to make the second main imaging pattern 1322 an upward arrow pattern, and the projected pattern of the floating display image 1000a is correspondingly an upward arrow pattern, but not limited thereto. This is well known by a person skilled in the art, and it will not be described in detail herein. In this embodiment, the first main imaging pattern 1312 and the second main imaging pattern 1322 have the same pattern. The user can see the floating display image 1000a in the front-viewing first viewing angle V1 after projection, as shown in FIG. 8.

Referring to FIGS. 1 and 7, in this embodiment, the base imaging pattern 1324 of the second sub-imaging unit 1320u is located around the second main imaging pattern 1322. For example, the base imaging pattern 1324 may surround the second main imaging pattern 1322 to enhance the display effect of the base imaging pattern 1324, but not limited thereto. The base imaging pattern 1324, for example, may be only half of a pattern disposed on the right half side or the left half side, or disposed at the four sides or the four corners (not shown). By adjusting the ratio of the pattern area of the base imaging pattern 1324, the light transmitting gray scale effect of the auxiliary imaging pattern 1330 can be correspondingly adjusted, and thus the brightness of the auxiliary display imaging at a tilted angle can be correspondingly adjusted. In this embodiment, a plurality of the second sub-imaging units 1320u form the auxiliary display image 1330. The auxiliary imaging pattern 1330 has the same or similar pattern as the first main imaging pattern 1312. The auxiliary display image can be seen from the second viewing angle V2 and the third viewing angle V3 after the auxiliary imaging pattern 1330 is projected, as shown in FIG. 8. In this embodiment, the second main imaging pattern 1322 and the base imaging pattern 1324 respectively use a light transmitting pattern as an example. In addition to the black-white and gray scale display, a color filter layer (not shown) may be disposed at the first main imaging pattern 1312, the second main imaging pattern 1322, and the base imaging pattern 1324 of the instant disclosure, and matched with the display light source 200 having a white light source to achieve the effect of color display.

In addition, referring to FIG. 7 and cross-referencing FIGS. 5A and 5B, each of the second sub-imaging units 1320u respectively has a base imaging patter 1324, and the base imaging pattern 1324 of the second sub-imaging unit 1320u is located around the second main imaging pattern 1322. Therefore, the auxiliary imaging pattern 1330 has the highest light transmitting effect. When the user sees the auxiliary display image at a tilted angle, the auxiliary display pattern has the brightest gray scale, and has the highest display contrast ratio to the peripheral light shielding part. If it is required by the product, the ratio of the base imaging pattern 1324 in the auxiliary imaging pattern 1330 may also be adjusted, and thereby adjusting the gray scale display effect of the auxiliary imaging pattern 1330. The second sub-imaging units 1320u with the base imaging pattern 1324 may be arranged in, for example, a chessboard arrangement, a strip-like alternative arrangement, a triangle staggered arrangement, a square staggered arrangement, a random staggered arrangement, etc., but not limited thereto. The details of the adjusting method may be referred to the descriptions about FIG. 5A and FIG. 5B.

Refer to FIG. 1, FIG. 7 and FIG. 8. The optical imaging sheet 300 of the floating display device with a wide viewing angle in FIG. 1 is correspondingly represented in FIG. 8 by only the key optical imaging sheet 1300. The optical imaging sheet 1300 includes the first main imaging pattern 1312, the second imaging pattern 1322 and the auxiliary imaging pattern 1330. The floating display device 100 of the instant disclosure can achieve a wide viewing angle effect. When the user sees the optical imaging sheet 1300 of the floating display device 100 from the front-viewing the first viewing angle V1, and the first main imaging pattern 1312 and the second main imaging pattern 1322 are projected to generate the floating display image 1000a, since the user is located in the range of the field of view (FOV) 1200 for front viewing, an excellent floating display image 1000a can be seen, but is limited to the range of the viewing angle θ1. For example, if the normal direction vertical to the center of the plane of the optical imaging sheet 1300 is 0 degree (not shown), depending on the limitation of the viewing angle of the product, the viewing angle θ1 may be, for example ±25 degrees. The viewing angle θ1 limits the viewing angle of the user, and it also limits the application of the product. The floating display device 100 with a wide viewing angle of the instant disclosure further provides an auxiliary display image projected by the auxiliary imaging pattern 1330 of the optical imaging sheet 1300, which can increase the viewing angle to a viewing angle θ2, such as ±50 degrees. The user can see the auxiliary display image at the deviated top second viewing angle V2 (+25 degrees to +50 degrees) and the deviated lower third viewing angle V3 (−25 degrees to −50 degrees), and thus the auxiliary viewing angles α1 and α2 are added. The added part of the auxiliary display image is a 3D viewing angle. When the user deviates the front-viewing first viewing angle V1, regardless of whether the deviation is upward, downward, left or right, the user can still see the display image, and it is not limited to the demonstration illustrated in FIG. 8. Compared to the conventional technology, with which the user only can only see from the first viewing angle V1 with a small viewing angle θ1, the instant disclosure provides an auxiliary display image with an increased viewing angle θ2 and added the deviated viewing angles α1 and α2, allowing the user to see the auxiliary display image even from the deviated second viewing angle V2 and third viewing angle V3. Hence, the floating display device 100 with a wide viewing angle of the instant disclosure increases the range of application and improves the user's viewing experience of the floating display device. In addition to the upward arrow pattern for the floating display image 1000a illustrated in FIG. 8, the optical imaging sheet 1300 may also use various other different patterns such as number patterns, direction patterns, switch on/off patterns, text patterns, etc., and the floating display image 1000a is correspondingly formed with the above patterns, but not limited thereto, and the details will not be described in detail herein.

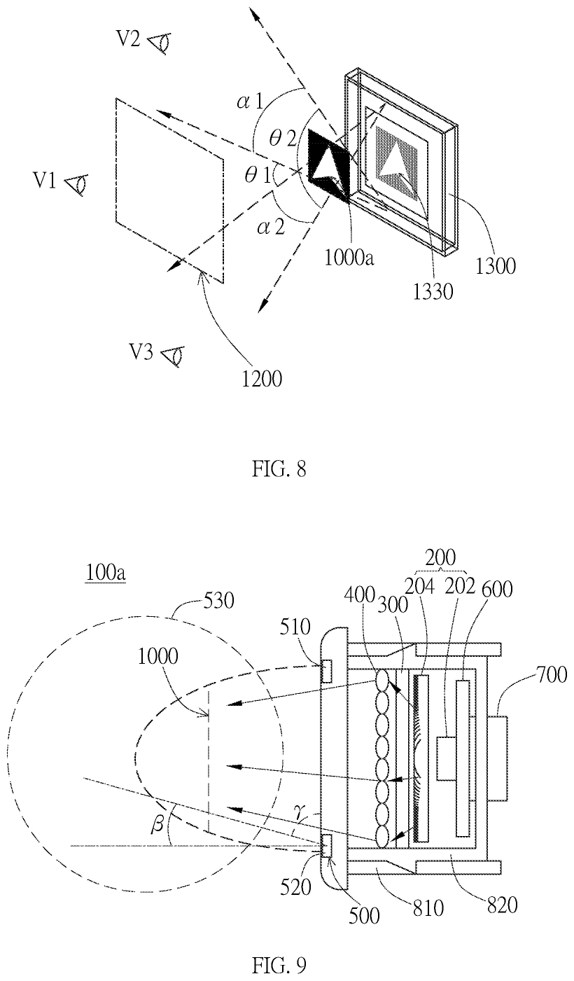

The floating display device 100 with a wide viewing angle of the instant disclosure may apply to various equipment, such as elevator buttons, machine buttons, machine touch screen, etc., but not limited thereto. In addition, when matched with a floating touch function, the floating display device 100 can have an excellent floating display touch effect. FIG. 9 is a schematic cross-sectional view of the floating display device in another embodiment of the instant disclosure. In this embodiment, similar to the previous embodiments in FIGS. 1-8, the same reference numbers are used for cross-referencing, but not limited thereto. In this embodiment, an elevator button is used as an example. A person skilled in the art may apply to other equipment, not limited to the illustrations of the instant disclosure.

Referring to FIG. 9, the floating display device with a wide viewing angle 100a at least comprises a display light source 200, an optical imaging sheet 300 and a micro-lens array (MLA) sheet 400. The display light source 200, for example, may include a Light Emitting Diode (LED) 202 and a light diffuser 204. The LED 202 can emit, for example, various visible light beams such as white light beams, blue light beams, green light beams, red light beams, etc., wherein the light wavelength range may be adjusted depending on the product requirement. There may be at least one LED 202 disposed; there may be a single LED 202 disposed, or a plurality of LEDs 202 arranged in an array, but not limited thereto. The light diffuser 204 can uniformly diffuse the light beams provided by the LED 202 to form a planar light source for projecting the floating display image 1000 with the auxiliary display image at a tilted viewing angle.

Referring FIG. 9, the optical imaging sheet 300 of the instant disclosure may be an optical imaging sheet 300 with a light shielding pattern, or an optical imaging sheet 1300 with a light transmitting pattern, but not limited thereto. Regarding the optical imaging sheet 300 (or the optical imaging sheet 1300), one may refer to the descriptions of the previous embodiments, and it will not be described in detail herein. A biconvex lens may be adopted for the MLA sheet 400 to achieve an excellent floating display effect. Regarding the MLA sheet 400, one can refer to the descriptions of the previous embodiments, and it will not be described in detail herein. The floating display image 1000 (or the floating display image 1000a) is formed by projecting with the display light source 200, the optical imaging sheet 300 and the MLA sheet 400. The imaging angle may be adjusted by adjusting the projection display system, such as adjusting the projective object distance and image distance. For example, one may adjust the narrowing angle β to be between 10 degrees and 45 degrees, so that an imaging angle γ may be between 80 degrees and 45 degrees. By properly adjusting the imaging angle γ, the distance between the floating display image 1000 and the MLA sheet 400, e.g., between 0.1 centimeters (cm) and 20 cm, can be therefore adjusted to adjust the floating display projecting distance. In practice, depending on the usage requirements, the floating display projecting distance used may be, for example, between 0.5 cm and 10 cm. The above is illustrated as an example, but it does not limit the floating display projecting range.

Referring to FIG. 9, when the floating display device 100a is applied to an elevator button, it may optionally further comprise a circuit board 600 such as a printed circuit board, disposed adjacent to the display light source 200. An LED 202 of the display light source 200 may be, for example, directly disposed on the circuit board 600 to further save space. On the side of the circuit board 600 opposite to the LED 202, a connector 700 may be connected to the circuit board 600 to electrically connect the circuit board 600 to an external control circuit. In addition, as shown in FIG. 9, the floating display device 100a may further comprise an outer shell 810 and an inner shell 820. The display light source 200, the optical imaging sheet 300, the MLA sheet 400, the circuit board 600, etc., may be disposed inside the inner shell 820 and electrically connected to the external circuit by the connector 700. By interlocking the outer shell 810 and the inner shell 820, the display light source 200, the optical imaging sheet 300, the MLA sheet 400, and the circuit board 600 may be sealed in the accommodating space between the outer shell 810 and the inner shell 820. A transparent substrate (not shown) as a display projecting window of the outer shell 810 is exposed and close to the MLA sheet 400 for projecting the floating display image 1000 with the auxiliary display image at a tiled angle. This can increase display viewing angle to achieve the wide viewing angle display effect, and the user at a tilted angle can still see the auxiliary display image.

Referring to FIG. 9, the floating display device 100a may further comprise a touch sensing module 500 disposed next to the MLA sheet 400 to form a floating display touch equipment. The touch sensing module 500 may be, for example, a floating touch sensing module, and has a touch sensing region 530 in combination with the floating display device 100 to achieve an excellent floating display touch sensing effect. The touch sensing module 500, for example, may use an infrared light touch sensing technology, a visible light photography analysis touch sensing technology, a sonic touch sensing technology, etc. to obtain an excellent floating touch sensing effect and prevent germ transmissions due to touching the object surface. Using the infrared display touch sensing technology as an example, the touch sensing module 500 at least comprises an infrared light-emitting element 510 and an infrared light-sensing element 520 that are respectively disposed, for example, at two opposite sides of the outer shell 810 adjacent to the MLA sheet 400, as shown in FIG. 9. The infrared light-emitting element 510 and the infrared light-sensing element 520, for example, may respectively be electrically connected to the circuit board 600. A light emitting angle range of the infrared light-emitting element 510 may overlap with a light receiving angle range of the infrared light-sensing element 520 to form a touch sensing region 530, wherein the scope of the touch sensing region 530 may contain the floating display image 1000 (or 1000a). Part of the infrared light beams emitted from the infrared light-emitting element 510 is projected to the position of the floating display image 1000. When a user's finger reaches the touch sensing region 530 and is about to touch the floating display image 1000, the infrared light beams are reflected to the infrared light-sensing element 520, such that the action of the user can be detected to achieve a human-machine floating touch sensing function. Hence, when the user takes the elevator, the user just needs to touch the floating display image 1000 so that the effect of touching a floating elevator touch button can be achieved, without needing to directly touch the elevator button. Accordingly, access to the germs attached to the elevator buttons can be prevented and thus the chance of spreading germs can be reduced. Furthermore, the infrared light-emitting element 510 and the infrared light-sensing element 520 are not limited to being disposed on the outer shell 810. The infrared light-emitting element 510 may be disposed outside the outer shell 810, such as regions above or below the shell, and emit infrared light beams substantially parallel to the floating display image 1000, so that the number of the infrared light-sensing element 520 disposed on the outer shell 810 may be increased, and the sensitivity of touch sensing can be therefore increased. If the sensitivity of the of the infrared light-sensing element 520 is high enough, it may directly sense the infrared light beams emitted by the body of the user. The infrared light-sensing element 520 may be directly disposed on the outer shell 810 and the infrared light-emitting element 510 can be omitted. The above description is used as an example, and a person skilled in the art can make appropriate substitutions to achieve the floating display touch sensing effect, and it will not be described in detail herein.

In summary, the instant disclosure provides a floating display device that uses second sub-imaging units to arrange and form auxiliary imaging patterns. A base imaging pattern is added to the second main imaging pattern of the second sub-imaging unit to enhance the effect of the auxiliary imaging pattern. By utilizing the auxiliary display image provided by the auxiliary imaging pattern, the user at a tilted angle can still see the auxiliary display image, thereby achieving the effect of a wide viewing angle, and the user's experience of the floating display device can be improved. Furthermore, a floating display touch device with a wide viewing angle can be constructed by matching the floating display device with a touch sensing module, which can further achieve a floating touch human-machine interaction effect. The problem of germ transmission caused by the user's direct touching can be therefore reduced.

Although the preferred embodiments of the instant disclosure have been described herein, the above description is merely illustrative. The preferred embodiments disclosed will not limit the scope of the instant disclosure. Further modification of the instant disclosure herein disclosed will occur to a person skilled in the art and all such modifications are deemed to be within the scope of the instant disclosure as defined by the appended claims.

What is claimed is:

1. A floating display device, comprising:
a display light source;
a micro-lens array sheet, disposed corresponding to the display light source, and the micro-lens array sheet having a plurality of micro-lenses arranged in array; and
an optical imaging sheet, disposed between the display light source and the micro-lens array sheet, the optical imaging sheet having a plurality of sub-imaging units arranged in array corresponding to the micro-lenses, and the plurality of sub-imaging units comprising:
a plurality of first sub-imaging units, each of the first sub-imaging unit having a first main imaging pattern; and
a plurality of second sub-imaging units, each of the second sub-imaging unit having a second main imaging pattern, the first main imaging pattern and the second main imaging pattern having the same pattern, wherein the plurality of second sub-imaging units is arranged to construct an auxiliary imaging pattern, at least a number of the second sub-imaging units respectively has a base imaging pattern, and the base imaging pattern is located around the second main imaging pattern.

2. The floating display device of claim 1, wherein the display light source includes at least a light-emitting diode and a light diffuser.

3. The floating display device of claim 1, wherein the micro-lens includes a biconvex lens.

4. The floating display device of claim 1, wherein each of the first main imaging pattern, the second main imaging pattern and the base imaging pattern respectively includes a light shielding pattern.

5. The floating display device of claim 1, wherein each of the first main imaging pattern, the second main imaging pattern and the base imaging pattern respectively includes a light transmitting pattern.

6. The floating display device of claim 1, wherein the base imaging pattern surrounds the second main imaging pattern.

7. The floating display device of claim 1, wherein each of the second sub-imaging units includes the base imaging pattern.

8. The floating display device of claim 1, wherein an arrangement of a part of the second sub-imaging units having the base imaging pattern includes a chessboard pattern arrangement.

9. The floating display device of claim 1, wherein the optical imaging sheet further includes a transparent substrate, and the sub-imaging units arranged in array are configured on the transparent substrate.

10. The floating display device of claim 1, wherein the first main imaging pattern and the auxiliary imaging pattern have the same pattern.

11. The floating display device of claim 1, wherein the display light source, the optical imaging sheet and the micro-lens array sheet are projected to form a floating display image.

12. The floating display device of claim 11, further comprises a touch sensing module disposed adjacent to the micro-lens array sheet, and the touch sensing module has a touch sensing region, which has a region range to contain the floating display image.

13. The floating display device of claim 12, wherein the touch sensing module includes an infrared light-emitting element and an infrared light-sensing element, and the infrared light-emitting element and the infrared light-sensing element are located at two sides of the micro-lens array sheet.

14. a floating display touch device, comprising:
a display light source;
a micro-lens array sheet, disposed corresponding to the display light source, and the micro-lens array sheet having a plurality of micro-lenses arranged in array;
a touch sensing module, disposed adjacent to the micro-lens array sheet; and
an optical imaging sheet, disposed between the display light source and the micro-lens array sheet, the optical imaging sheet having a plurality of sub-imaging units arranged in array corresponding to the micro-lenses, and the plurality of sub-imaging units comprising:
a plurality of first sub-imaging units, each of the first sub-imaging unit having a first main imaging pattern; and
a plurality of second sub-imaging units, each of the second sub-imaging unit having a second main imaging pattern, the first main imaging pattern and the second main imaging pattern having the same pattern, wherein the plurality of second sub-imaging units is arranged to construct an auxiliary imaging pattern, at least a number of the second sub-imaging units respectively has a base imaging pattern, and the base imaging pattern is located around the second main imaging pattern.

15. The floating display touch device of claim 14, wherein each of the first main imaging pattern, the second main imaging pattern and the base imaging pattern respectively includes a light shielding pattern.

16. The floating display touch device of claim 14, wherein each of the first main imaging pattern, the second main imaging pattern and the base imaging pattern respectively includes a light transmitting pattern.

17. The floating display touch device of claim 14, wherein the base imaging patterns surrounds the second main imaging pattern.

18. The floating display touch device of claim 14, wherein each of the second sub-imaging units includes the base imaging pattern.

19. The floating display touch device of claim 14, wherein an arrangement of a part of the second sub-imaging units having the base imaging pattern includes a chessboard pattern arrangement.

20. The floating display touch device of claim 14, wherein the optical imaging sheet further includes a transparent substrate, the sub-imaging units arranged in array are configured on the transparent substrate.

21. The floating display touch device of claim 14, wherein the first main imaging pattern and the auxiliary imaging pattern have the same pattern.

22. The floating display touch device of claim 14, wherein the display light source, the optical imaging sheet and the micro-lens array sheet are projected to form a floating display image.

23. The floating display touch device of claim 22, wherein the touch sensing module has a touch sensing region, which has a region range to contain the floating display image.

24. The floating display touch device of claim 14, wherein the touch sensing module includes an infrared light-emitting element and an infrared light-sensing element, and the infrared light-emitting element and the infrared light-sensing element are located at two sides of the micro-lens array sheet.
